(19) United States
(12) Patent Application Publication
(10) Pub. No.: US 2018/0093389 A1
(43) Pub. Date: Apr. 5, 2018

(54) Dovetailing Device

(71) Applicant: Matthew Aaron Cochran, Santa Ana, CA (US)

(72) Inventor: Matthew Aaron Cochran, Santa Ana, CA (US)

(21) Appl. No.: 15/724,178

(22) Filed: Oct. 3, 2017

Related U.S. Application Data
(60) Provisional application No. 62/404,193, filed on Oct. 4, 2016.

(51) Int. Cl. B27F 1/08

(52) U.S. Cl. CPC B27F 1/08

(57) ABSTRACT

A device which prepares material for being held in a dovetail style workholding system, such as a dovetail vise. The device uses a number of cutters to produce a dovetail shape in the stock material.

### CROSS-REFERENCE TO RELATED APPLICATIONS

This application claims the benefit of U.S. Application No. 62/404,193, which was filed on Oct. 4, 2016.

### BACKGROUND

### Technical Field

This application generally concerns machining operations and the securing of material (workholding) to perform such operations.

### Background

Machining operations cut away parts of a material to produce a desired product.

### SUMMARY

Dovetail workholding systems require that you prepare your material to be machined by producing a dovetail feature (usually milled) into the material stock which matches the dovetail shape on the workholding system. This material preparation operation does not add value to the part as the dovetail feature is typically removed after the holding in the dovetail system is complete and before the part is shipped or put into inventory. Additionally, creating the dovetail feature requires shop resources (time, a machining center, etc.) that could otherwise be allocated to value added operations on the part.

Some embodiments of a device comprise a body and two or more cutters that are configured to cut a dovetail into a piece of material that is fed through the two or more cutters.

Some embodiments of a device comprise a body and means for cutting two sides of a dovetail in a piece of material.

Some embodiments of a device comprise a body that has a substantially flat surface and one or more cutters that are configured to cut a dovetail into a piece of material that abuts the flat surface and is moved past the cutter.

### BRIEF DESCRIPTION OF THE DRAWINGS

FIG. 1 is a perspective view of an example embodiment of system for preparing material.

FIG. 2 is a front view of the example embodiment of a system for preparing material that is shown in FIG. 1.

FIG. 3 shows a section view of the example embodiment of a system from FIGS. 1 and 2, taken from line A-A.

FIG. 4 illustrates a zoomed-in view of area B from FIG. 3.

FIG. 5 illustrates some of the adjustable dimensions of an example embodiment of a dovetail protuberance.

FIG. 6 illustrates a front view of an example embodiment of a dovetailing device.

FIG. 7 illustrates a side view of the example embodiment of a dovetailing device that is shown in FIG. 6.

FIG. 8 illustrates a front view of an example embodiment of a dovetailing device.

FIG. 9 illustrates a side view of the example embodiment of a dovetailing device that is shown in FIG. 8.

FIG. 10 illustrates a front view of an example embodiment of a dovetailing device.

FIG. 11 illustrates a side view of the example embodiment of a dovetailing device that is shown in FIG. 10.

FIG. 12 illustrates a front view of an example embodiment of a dovetailing device.

FIG. 13 illustrates a side view of the example embodiment of a dovetailing device that is shown in FIG. 12.

FIG. 14 illustrates a top view of an example embodiment of a dovetailing device.

FIG. 15 illustrates a front view of the example embodiment of a dovetailing device that is shown in FIG. 14.

FIG. 16 illustrates a side view of the example embodiment of a dovetailing device that is shown in FIG. 15.

FIG. 17 illustrates a top view of an example embodiment of a dovetailing device.

FIG. 18 illustrates a front view of the example embodiment of a dovetailing device that is shown in FIG. 17.

FIG. 19 illustrates a side view of the example embodiment of a dovetailing device that is shown in FIG. 18.

FIG. 20 is a perspective view of an example embodiment of a dovetailing device.

FIG. 21 shows a section view of the material (as seen from line C-C in FIG. 5) with a locating feature.

### DETAILED DESCRIPTION

The following paragraphs describe illustrative embodiments. Other embodiments may include alternatives, equivalents, and modifications.

FIG. 1 is a perspective view of an example embodiment of a system for preparing material. The system 100 includes a dovetailing device 1, a material conveyor 4, two vertical guides 12, and two horizontal guides 13. The system 100 is also coupled to a band saw 3. The material conveyor 4 holds a piece of material 2. The material conveyor 4, the vertical guides 12, and the two horizontal guides 13 direct the material through the dovetailing device 1. The material 2 may be propelled through the dovetailing device 1 by a user, by the material conveyor 4, or by another device (e.g., linear actuator, a powered clamp). Also, the dovetailing device 1 may pull the material 2 through.

The material conveyor 4 may include a conveyor belt, rollers, etc. The material conveyor 4 may also include a ridge or a fence on the same side of the material conveyor 4 as the dovetailing device 1.

The vertical guides 12 includes rollers (e.g., wheels) that allow the material 2 to move past the vertical guides 12 while the vertical guides 12 exert a downward force to hold the material 2.

The horizontal guides 13 includes rollers (e.g., wheels) that allow the material 2 to move past the horizontal guides 13 while the horizontal guides 13 exert a lateral force to hold the material 2 (e.g., hold the material against the dovetailing device 4, hold the material against a fence of the material conveyor 4).

The dovetailing device 1 includes one or more cutters that cut a one-sided or two-sided dovetail into a side of the material 2. Also, the dovetail may be a male dovetail or a female dovetail. The dovetailing device 1 does not limit the length of the material 2 that is fed through it. In this embodiment, the dovetailing device 1 remains stationary while the material 2 passes through the cutters, although in some embodiments the dovetailing device 1 moves relative to the material 2. Thus, the dovetailing device 1 allows an operator to to create the dovetail feature on the material without using a machining center (e.g., mill, wire EDM).

After the material 2 has passed through the dovetailing device 1, which cuts a dovetail into the material 2, the material 2 may be cut into smaller pieces (e.g., pieces of a desired length), which can then be operated on in a machining center.

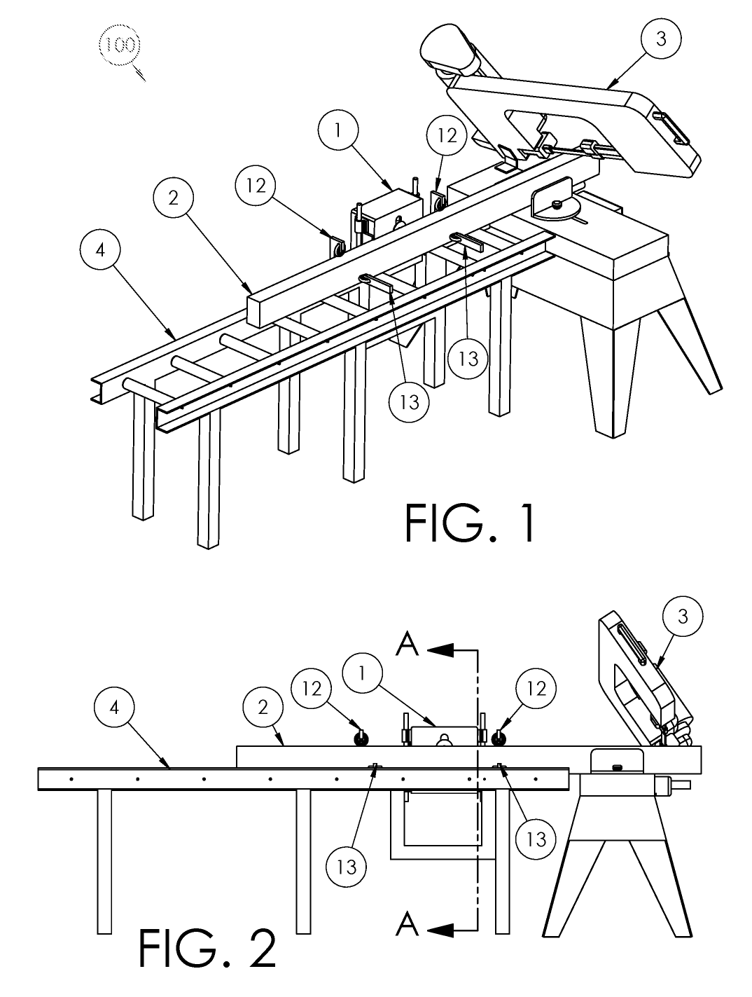

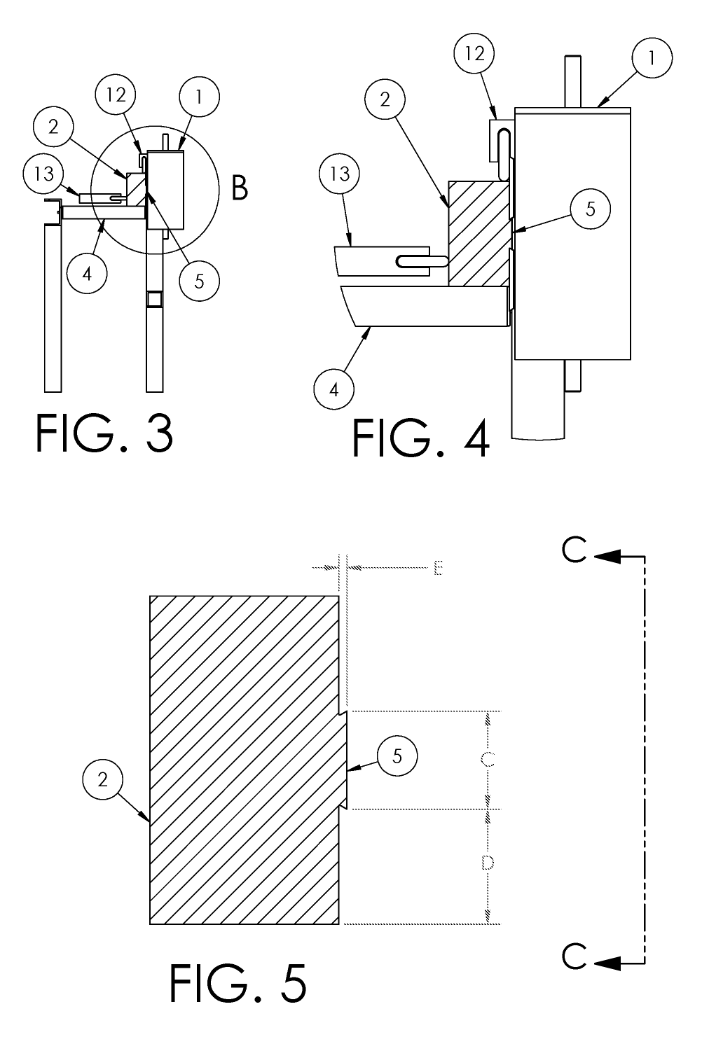

FIG. 2 is a front view of the example embodiment of a system for preparing material that is shown in FIG. 1. FIG. 2 includes a line A-A, and FIG. 3 shows a section view of the example embodiment of a system from FIGS. 1 and 2, taken from line A-A.

FIG. 3 shows another perspective of the positions of the horizontal guides 13 and the vertical guides 12 relative to the material 2. In this example, the horizontal guides 13 and the vertical guides 12 hold the material 2 so that the material 2 abuts a depth-control member of the dovetailing device 1.

FIG. 4 illustrates a zoomed-in view of area B from FIG. 3. FIG. 4 shows a dovetail protuberance 5 that has been cut into the material 2 and the two cutters 9 of the dovetailing device 1. Although FIG. 4 shows a male dovetail in the material 2, some embodiments of the cutting device 1 cut a female dovetail into the material 2. Also, FIG. 4 shows the horizontal guide 13 and the vertical guide 12, which ensure that the material 2 does not move off course when the material 2 encounters cutting forces that might otherwise affect the location of the dovetail protuberance 5.

The positions of the cutters 9 may be changed. For example, the cutters 9 may be spaced further apart, which increases the width of the dovetail protuberance 5. Also, both cutters 9 may be moved up or down to change the vertical position of the protuberance 5 on the material 2. FIG. 5 illustrates some of the adjustable dimensions of the an example embodiment of a dovetail protuberance 5. The width C of the dovetail protuberance 5 can be altered by changing the cutting space between the cutters 9. Also, the depth E of the dovetail protuberance 5 can be altered by moving a depth-control member. And the location D of the bottom edge of the dovetail protuberance 5 can be altered by moving the dovetailing device 1 (and thus the two cutters 9) up or down relative to the material 2, for example by using a vertical-adjustment member.

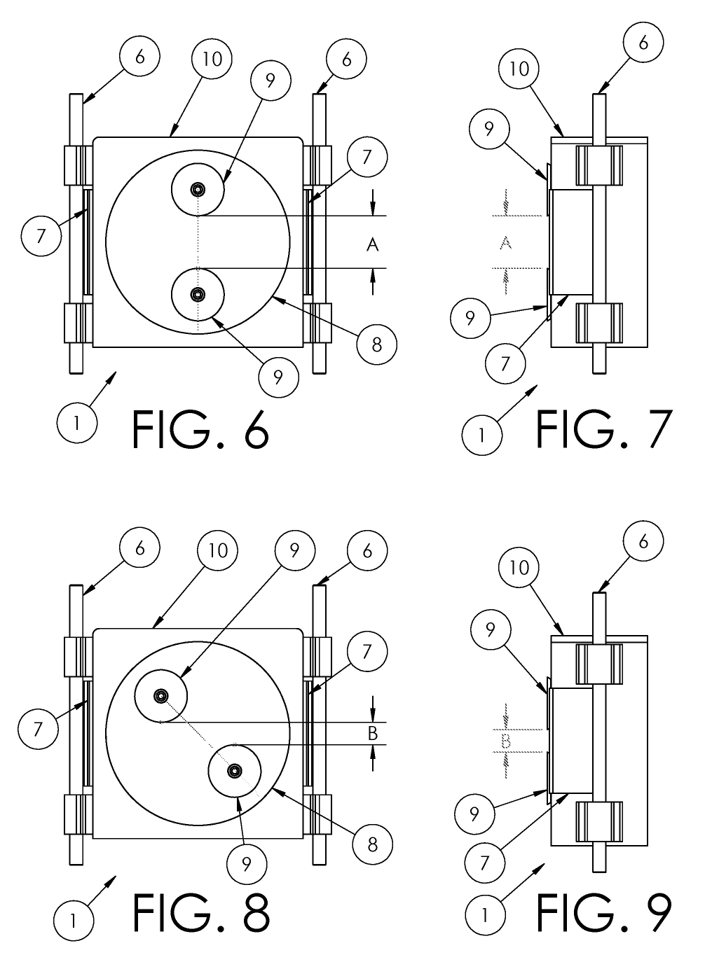

FIG. 6 illustrates a front view of an example embodiment of a dovetailing device. The dovetailing device 1 includes two cutters 9, two depth-control members 7, two vertical-adjustment members 6, a body 10, and a cutting-space-adjustment member 8. In this embodiment, the cutting-space-adjustment member 8 can be rotated, which changes the cutting space A between the two cutters 9. Because a material passes through the two cutters 9 in a horizontal direction, rotating the cutting-space-adjustment member 8 in FIG. 6 clockwise or counterclockwise from the illustrated position will decrease the cutting space A.

FIG. 7 illustrates a side view of the example embodiment of a dovetailing device that is shown in FIG. 6. The depth-control members 7 can be moved left and right in this perspective, which alters the depth of a dovetail that is cut by the two cutters 9.

FIG. 8 illustrates a front view of an example embodiment of a dovetailing device. The dovetailing device 1 includes two cutters 9, two depth-control members 7, two vertical-adjustment members 6, a body 10, and a cutting-space-adjustment member 8. In FIG. 8, the cutting-space-adjustment member 8 has been rotated counter-clockwise relative to the cutting-space-adjustment member 8 in FIG. 6. Thus, the cutting space B in FIG. 8 is more narrow than the cutting space A in FIG. 6.

FIG. 9 illustrates a side view of the example embodiment of a dovetailing device that is shown in FIG. 8. In FIG. 9, the cutting space B is more narrow than the cutting space A in FIG. 7.

FIG. 10 illustrates a front view of an example embodiment of a dovetailing device. The dovetailing device 1 includes two cutters 9, two depth-control members 7, two vertical-adjustment members 6, a body 10, and two cutting-space-adjustment members 8. In this embodiment, the cutting-space-adjustment members 8 allow the cutters 9 to move up and down in this perspective, which changes the cutting space A between the two cutters 9.

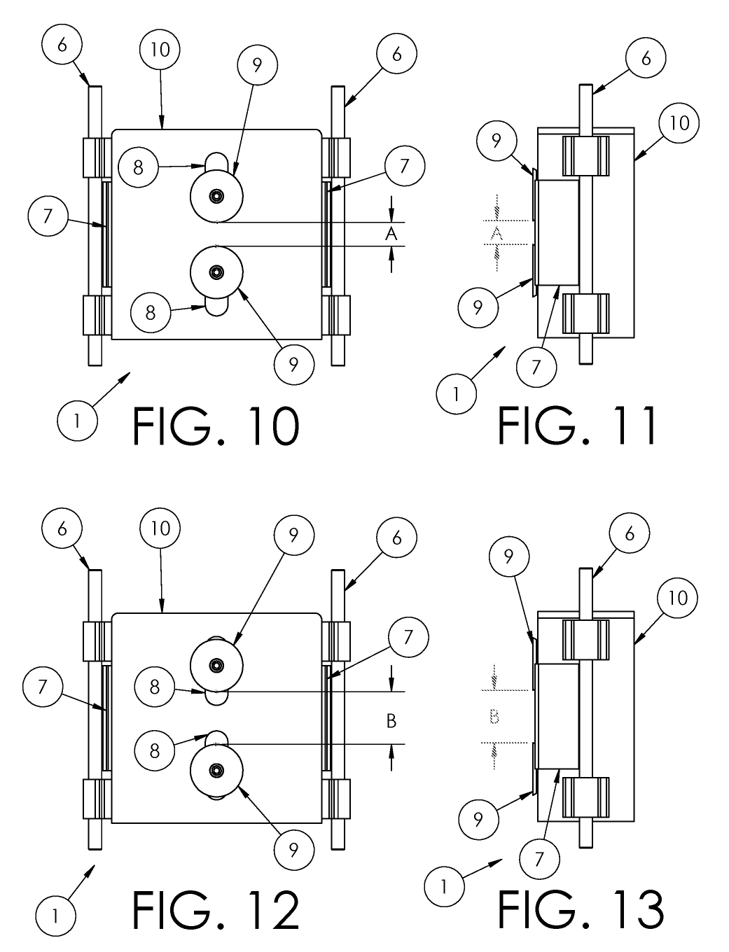

FIG. 11 illustrates a side view of the example embodiment of a dovetailing device that is shown in FIG. 10. The depth-control members 7 can be moved left and right in this perspective, which alters the depth of a dovetail that is cut by the two cutters 9.

FIG. 12 illustrates a front view of an example embodiment of a dovetailing device. The dovetailing device 1 includes two cutters 9, two depth-control members 7, two vertical-adjustment members 6, a body 10, and a cutting-space-adjustment member 8. In FIG. 10, the cutting-space-adjustment member 8 has allowed the cutters to move away from each other relative to the cutting-space-adjustment member 8 in FIG. 10. Thus, the cutting space B in FIG. 12 is more wide than the cutting space A in FIG. 10.

FIG. 13 illustrates a side view of the example embodiment of a dovetailing device that is shown in FIG. 12. In FIG. 9, the cutting space B is more wide than the cutting space A in FIG. 11.

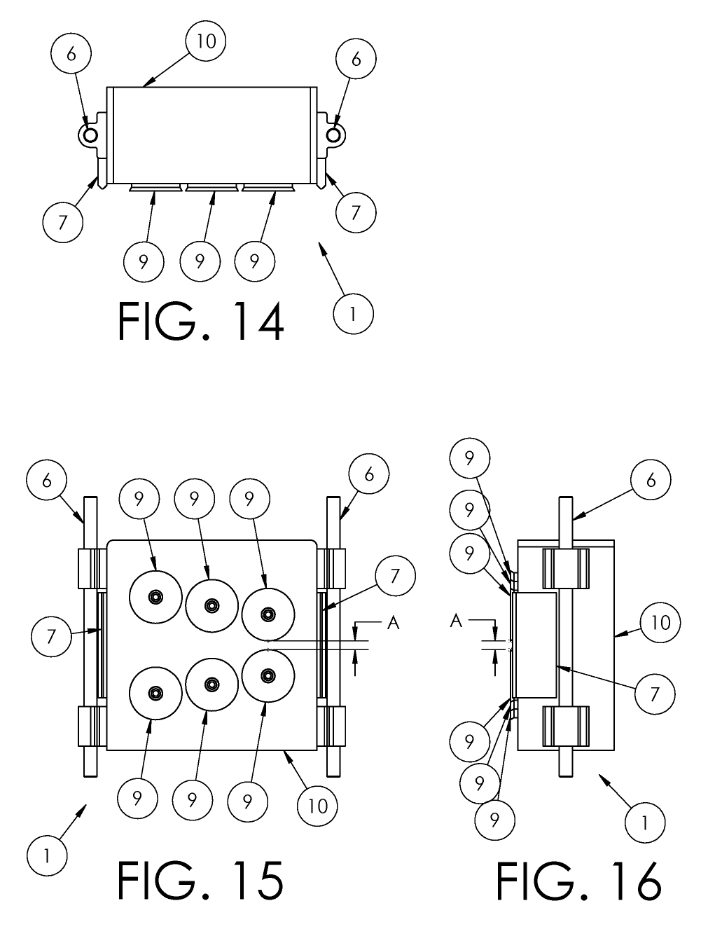

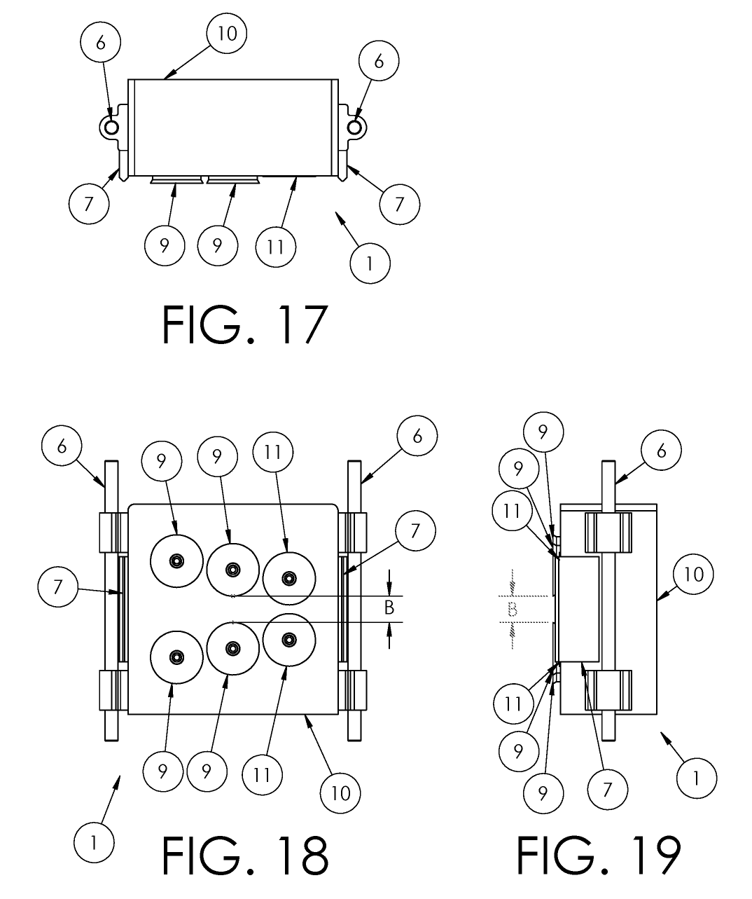

FIG. 14 illustrates a top view of an example embodiment of a dovetailing device 1. The dovetailing device 1 includes six cutters 9 (although only three cutters are visible in this view), two depth-control members 7, two vertical-adjustment members 6, and a body 10. In this embodiment, the cutting-space-adjustment is changed by selecting which cutters 9 are engaged with the material (e.g., which cutters 9 extend past the surface of the depth-control member 7). In the embodiment of FIG. 14, all six cutters 9 (including the three visible cutters 9 in FIG. 14) extend past the surface of the two depth-control members 7. In comparison, FIG. 17 illustrates an embodiment in which two of the cutters 9 are engaged and one cutter 11 is not engaged, thus not affecting the width of the finished dovetail (dimension C in FIG. 5).

FIG. 15 illustrates a front view of the example embodiment of a dovetailing device that is shown in FIG. 14. The material to be cut enters the dovetailing device from the left side of the dovetailing device where it first engages the left-most pair of cutters 9, and a dovetail of width H is created in the material. As the material continues to the right it encounters the center pair of cutters 9, and the width of the dovetail is reduced from width H to width B. Continuing, the material encounters the right-most pair of cutters, and the width of the dovetail is further decreased to width A. Upon exiting the dovetailing device, the final width of the dovetail in the material is determined by the last pair of cutters it encounters (in this example the final width is width A).

FIG. 16 illustrates a side view of the example embodiment of a dovetailing device that is shown in FIG. 15. The depth-control members 7 can be moved left and right in this perspective, which alters the depth of a dovetail that is cut by the six cutters 9.

FIG. 17 illustrates a top view of an example embodiment of a dovetailing device. The dovetailing device 1 includes six cutters 9 (three of which are visible in FIG. 17), two depth-control members 7, two vertical-adjustment members 6, and a body 10. In this embodiment, the cutting-space-adjustment is changed by selecting which cutters are engaged with the material, which are the cutters 9 that extend past the surface of the depth-control member 7. In FIG. 17, two of the cutters 9 extend past the surface of the two depth-control members 7, while one cutter 11 does not extend past the surface of the depth-control member and thus is not engaged and does not affect the width of the finished dovetail (dimension C in FIG. 5).

FIG. 18 illustrates a front view of the example embodiment of a dovetailing device that is shown in FIG. 17. The material to be cut enters the dovetailing device from the left side of the dovetailing device, where it first engages the left-most pair of cutters 9 and a dovetail of width H is created. As the material continues to the right it encounters the center pair of cutters 9, and the width of the dovetail is reduced from width H to width B. Continuing, the material does not encounter the right-most pair of cutters 11 because they are disengaged (e.g., retracted) from the material or removed from the dovetailing device, in some embodiments. Upon exiting the dovetailing device, the final width of the dovetail in the material is determined by the last pair of cutters 9 it encounters (dimension B in this example).

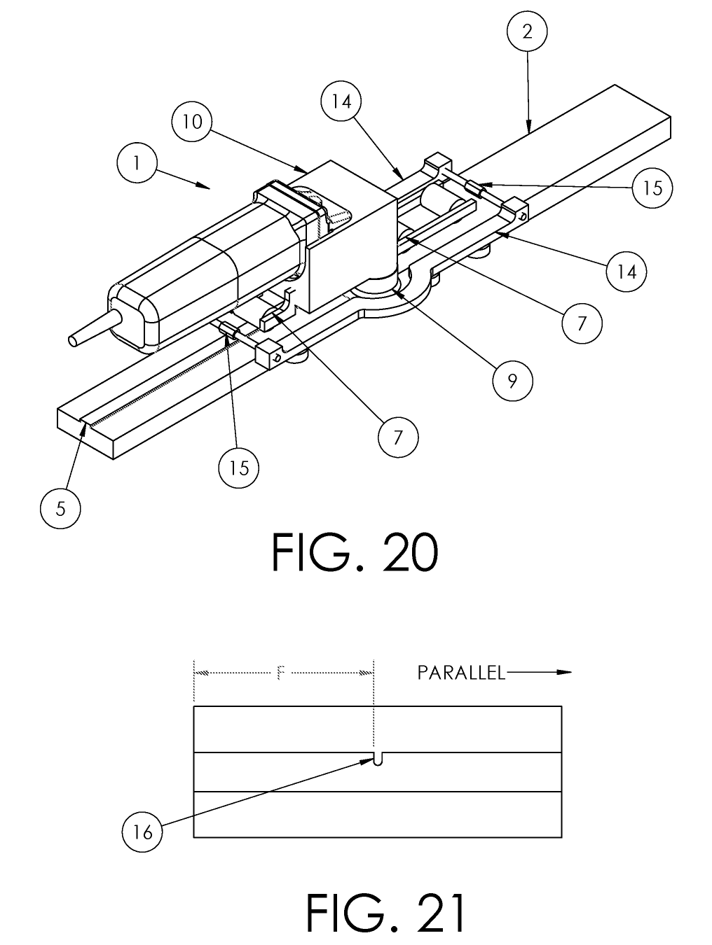

FIG. 19 illustrates a side view of the example embodiment of a dovetailing device that is shown in FIG. 18. The depth-control members 7 can be moved left and right in this perspective, which alters the depth of a dovetail that is cut by the six cutters 9.

FIG. 20 is a perspective view of an example embodiment of a dovetailing device. The dovetailing device 1 includes a body 10, one or more cutters 9, two depth-control members 7, two guides 14, and two guide-adjustment members 15. This dovetailing device 1 is a hand-held device that a user can move over a piece of material 2 to cut a dovetail 5 into the material 2. The two guides 14 hold the one or more cutters 9 at the same distance from the edges of the material 2 as the dovetailing device 1 is moved along the material 2. The two guide-adjustment members 15 can be adjusted to change the distance between the two guides 14, which allows the dovetailing device 1 to accommodate different sizes of material 2.

Some embodiments of the dovetailing device 1 have only one cutter 9. These embodiments can be moved over the length of the material 2 from one direction to cut a half dovetail 5 in the material 2, and then be moved over the material in the other direction, or from another side, to cut another half dovetail 5, thereby producing a full dovetail 5.

Additional embodiments can be used in conjunction with the dovetailing system 100 to produce a feature for locating the stock in the workholding device along the direction parallel to the dovetail. FIG. 21 shows a section view of the material (as seen from line C-C in FIG. 5) with said locating feature 16 at a distance from the edge of the material (Dimension F).

What is claimed is:

1. A device comprising:
a body; and
two or more cutters that are configured to cut a dovetail into a piece of material that passes between the two or more cutters.

2. The device of claim 1, further comprising:
a motor that drives the two or more cutters.

3. The device of claim 1, wherein the width of the dovetail is adjustable.

4. The device of claim 3, wherein a space between the two or more cutters is adjustable.

5. The device of claim 3, wherein an angle of attack of the two or more cutters is adjustable.

6. The device of claim 3, wherein cutters are engaged or disengaged.

7. The device of claim 1, further comprising:
a mechanism that feeds the material through the two or more cutters.

8. The device of claim 1, wherein the two or more cutters spin in a same direction.

9. The device of claim 1, wherein the two or more cutters spin in opposite directions.

10. A device comprising:
a body; and
means for cutting two sides of a dovetail in a piece of material.

11. The device of claim 10, further comprising:
means for adjusting a location of the dovetail on the piece of material.

12. The device of claim 10, wherein the means for cutting the two sides of the dovetail include two or more cutters.

13. The device of claim 12, further comprising:
means for adjusting a width of the dovetail.

14. The device of claim 12, further comprising:
means for adjusting an angle of attack of the two or more cutters.

15. A device comprising:
a body that has a substantially flat surface; and
one or more cutters that are configured to cut a dovetail into a piece of material that abuts the flat surface and is moved past the cutter.
